(19) United States
(12) Patent Application Publication
(10) Pub. No.: US 2025/0221876 A1
(43) Pub. Date: Jul. 10, 2025

(54) MULTI-DOF WEARABLE ASSISTANCE DEVICE

(71) Applicant: SEOUL NATIONAL UNIVERSITY R&DB FOUNDATION, Seoul (KR)

(72) Inventors: Yong Lae PARK, Seoul (KR); Jae In KIM, Seoul (KR); Jaeyoun CHOI, Seoul (KR); Junhyung KIM, Seoul (KR)

(73) Assignee: SEOUL NATIONAL UNIVERSITY R&DB FOUNDATION, Seoul (KR)

(21) Appl. No.: 18/558,069

(22) PCT Filed: Jul. 7, 2023
(86) PCT No.: PCT/KR2023/009623

§ 371 Date: Oct. 30, 2023

(30) Foreign Application Priority Data
Jul. 7, 2022 (KR) 10-2022-0083838

(51) Int. Cl. A61H 1/02

(52) U.S. Cl. CPC A61H 1/0274; A61H 1/0237; A61H 2201/1621; A61H 2201/163; A61H 2201/164

(57) ABSTRACT

Disclosed is a multi-DOF wearable assistance device, which is worn on a human body and assists movement, including: a plurality of blocks arranged to be spaced apart along the human body; a linear actuator disposed left and right in parallel between the neighboring blocks; and a joint connector providing a joint connection to freely change a connection angle between the block and opposite ends of the linear actuator.

This patent application is a US national stage application of PCT Patent Application No. PCT/KR2023/009623, filed on Jul. 7, 2023, which claims the benefit and priority of Korean Patent Application No. KR 10-2022-0083838 filed on Jul. 7, 2022, and entitled “MULTI-DOF WEARABLE ASSISTANCE DEVICE”, the disclosure of which is incorporated by reference herein in its entirety as part of the present application.

### TECHNICAL FIELD

The disclosure relates to a multi-DOF wearable assistance device, and more particularly to the multi-DOF wearable assistance device that can allow multi-degrees-of-freedom movement of an upper body and provide a multi-degrees-of-freedom assistive force for that movement based on anatomical characteristics of a human vertebra and erector spinae muscles.

### BACKGROUND

According to the National Institute for Occupational Safety and Health (U.S.), back injuries are the most frequent injuries and account for about 20% of all injuries that occur in the workplace. To prevent the back injuries, research and development on wearable devices have been actively ongoing for the past 10 years.

The wearable devices developed for the purpose of assisting human movement should be basically designed to have mechanics that allows movement aimed at assistance. Further, the wearable devices need to have an assistive mechanism that provides an assistive force for that movement. For example, a wearable device assisting a knee should be designed to have mechanics that follows the flexion/extension of the knee, and it is required to design power and power transmission parts necessary for assisting that movement. However, the existing wearable devices have limitations in designing the mechanism that allows such movements and transfers the assistive force.

In particular, a human upper body has multi-degrees-of-freedom movements such as forward-and-backward bending, left-and-right bending, and twisting due to vertebrae connected by multi-joints, and it is thus necessary to design a wearable device with the corresponding degrees of freedom. The size and weight of the device increase proportionally as the number of degrees of freedom of movement allowed by the device increases, and the power and the size and weight of power transmission parts increase as the number of auxiliary degrees of freedom increases, thereby causing a problem of wearability in the device.

### RELATED ART DOCUMENT

Korean Patent No. 10-2058649

Accordingly, the disclosure is conceived to solve the conventional problems described above, and an aspect of the disclosure is to provide a multi-DOF wearable assistance device, in which a plurality of blocks spaced apart along a human body and linear actuators disposed in parallel left and right between the neighboring blocks are connected by joints so that their connection angles to the blocks can change freely, thereby allowing multi-degrees-of-freedom movements such as forward-and-backward bending, left-and-right bending, and twisting and providing a multi-degrees-of-freedom assistive force for that movement.

The problems to be solved in the disclosure are not limited to those mentioned above, and other problems not mentioned will become apparent to those skilled in the art from the following description.

### Description

According to an embodiment of the disclosure, there is provided a multi-DOF wearable assistance device, which is worn on a human body and assists movement, including: a plurality of blocks arranged to be spaced apart along the human body; a linear actuator disposed left and right in parallel between the neighboring blocks; and a joint connector providing a joint connection to freely change a connection angle between the block and opposite ends of the linear actuator.

Here, wherein the joint connector may provide a ball-socket joint connection between the block and the linear actuator.

Here, the multi-DOF wearable assistance device may further include rotatory motors disposed left and right in parallel on an outer first side of an outermost block among the plurality of blocks, and each driving the plurality of linear actuators arranged in a row between the blocks, wherein the linear actuator receives a rotational force from the rotary motor and performs torsional rotation for linear contraction and expansion movements.

Here, the joint connector may include: a constant-velocity joint connector that provides a constant-velocity joint connection between the neighboring linear actuators arranged in a row with the blocks therebetween; and a ball-socket joint connector that provides a ball-socket joint connection between a housing of the constant-velocity joint connector and the block.

Here, the constant-velocity joint connector may include: a first side holder including a fastening portion for fastening a second end of the linear actuator disposed on a first side of the block, and an inner race formed on a shaft extending from the fastening portion; a plurality of balls disposed in the inner race; a cage maintaining a gap between the balls; an outer race; and a second side holder including a fastening portion for fastening a first end of the linear actuator disposed on a second side of the block, and fixed to a second side of the outer race.

Here, the ball-socket joint connector may include: the outer race having an outer surface formed as a partial spherical shape; and a socket formed in the block to insert the outer race therein and having an inner surface curved corresponding the outer surface of the outer race.

Here, the constant-velocity joint connection may be provided between the linear actuator and the outermost block on a first side among the plurality of blocks, and the constant-velocity joint connection may be provided between the rotary motor and the linear actuator disposed on the first side of the outermost block on a second side among the plurality of blocks.

Here, the multi-DOF wearable assistance device may further include: holding frames fixing two outermost blocks among the plurality of blocks, respectively; and a guide rail making a connection between the holding frames, wherein middle blocks among the plurality of blocks move up and down along the guide rail.

Here, the blocks moving up and down along the guide rail may rotate freely about a forward-and-backward directional axis.

Here, the multi-DOF wearable assistance device may further include: a guide block coupled to a bottom of a block moving up and down along the guide rail and rotating freely about the forward-and-backward directional axis; and a roller rotatably coupled to the guide block and rotating while being in contact with the guide rail.

Here, the guide rail may have a cross-section shaped like a cross-section of an I-beam, and the roller may include a rotating while supporting opposite recessed sides of the guide rail, and a vertical roller rotating while supporting a top of the guide rail.

Here, the guide rail may be formed of a flexible material.

Here, the multi-DOF wearable assistance device may further include: a flexible support frame connected between the holding frames, holding the guide rail, and formed of a flexible material to come into contact with a human body; and rail supporters fixed to the flexible support frame and supporting both sides of the guide rail.

Here, the rail supporter may include a horizontal roller fixed to the flexible support frame and horizontally rotating being in contact with a lateral side of the guide rail

Here, the linear actuator may include: four rails spaced apart in parallel and quadrangularly disposed; and a plurality of cross-shaped supporters disposed to be spaced apart in a longitudinal direction between the four rails, and including end portions connected to the rails, and rotation of the end portion of the rail may cause the rail to be bent and transformed rotating the plurality of cross-shaped supporters to change the length of the linear actuator.

Here, the cross-shaped supporter may include: a plurality of shaft members including a first end portion inserted in a fastening hole formed in each rail; a central connection member disposed at the center of the rail and formed with an insertion hole in which a second end portion of the shaft member is inserted; a linear bushing, a bearing, and an elastic member put on the shaft member and disposed between the rail and the central connection member; and a connection member fixing the first end portion of the shaft member from the outside of the rail, and the linear bushing may be movable in a longitudinal direction of the shaft member by elastic transformation of the elastic member upon rotation of the cross-shaped supporter due to a torsional force.

Here, the linear actuator may include: two rails disposed being spaced apart in parallel; and a plurality of transverse supporters disposed being spaced apart in a longitudinal direction between the rails, and including end portions connected to the rails, and rotation of the end portion of the rail may cause the rail to be bent and transformed rotating the plurality of transverse supporters to change the length of the linear actuator.

Here, the transverse supporter may include: a shaft member including both end portions inserted in a fastening hole formed in the rail; a first linear bushing, a first bearing, an elastic member, a second bearing, and a second linear bushing put on the shaft member and disposed in sequence; and a connection member fixing both end portions of the shaft member from the outside of the rail, and the linear bushing may be movable in a longitudinal direction of the shaft member by elastic transformation of the elastic member upon rotation of the transverse supporter due to a torsional force.

Here, the bearing may include a thrust bearing.

Here, the multi-DOF wearable assistance device may further include a wearable unit that includes: an upper body wearable unit including a chest strap to encircle a chest of a wearer and a shoulder strap to encircle a shoulder while connecting the front and back of the chest strap; a waist wearable unit including a waist strap to encircle a waist of the wearer; knee wearable units to be worn on both knees of the wearer; and foot wearable units to be worn on feet of the wearer, wherein the holding frames are fastened to the upper body wearable unit and the waist wearable unit, respectively, and a cable is connected between the waist wearable unit and the knee wearable unit and between the knee wearable unit and the foot wearable unit.

As described above, a multi-DOF wearable assistance device according to the disclosure has advantage of providing assistive forces for various movements of a human body without restricting those movements.

### DESCRIPTION OF DRAWINGS

FIG. 1 is a view illustrating a basic mechanism of a multi-DOF wearable assistance device according to an embodiment of the disclosure.

FIG. 2 is a view illustrating a concept of transmitting assistive forces corresponding to multi-degrees-of-freedom movements such as forward-and-backward bending, left-and-right bending, and twisting of a human upper body while allowing the multi-degrees-of-freedom movements by the mechanism of FIG. 1.

FIG. 3 is a perspective view of a main body in a multi-DOF wearable assistance device according to an embodiment of the disclosure.

FIG. 4 is an exploded perspective view of FIG. 3.

FIG. 5 is an exploded perspective view of a joint connector.

FIG. 6 is a detailed exploded perspective view of the joint connection disposed between linear actuators in FIG. 5.

FIG. 7 is an assembled perspective view of FIG. 6.

FIG. 8 is an enlarged view of a guide block and a rail supporter shown in FIG. 4.

FIG. 9 is a lateral view of the guide block coupled to a guide rail in FIG. 8.

FIG. 10 is a lateral view of the rail supporter coupled to the guide rail in FIG. 8.

FIG. 11 is a view illustrating two movement states of a linear actuator according to an embodiment.

FIG. 12 is an actual picture illustrating the movement of a multi-DOF wearable assistance device according to the disclosure based on forward-and-backward leaning movement.

FIG. 13 is an actual picture illustrating the movement of a multi-DOF wearable assistance device according to the disclosure based on leftward-and-rightward leaning movement.

FIG. 14 is a perspective view of a linear actuator according to an embodiment of the disclosure.

FIG. 15 is a view illustrating the linear actuator of FIG. 14 before twisting.

FIG. 15 is a drawing illustrating a state prior to the twisting in FIG. 14.

FIG. 16 is an exploded view of FIG. 15.

FIG. 17 is a view illustrating a rail in FIG. 16.

FIG. 18 is a view illustrating the arrangement of elements making up a horizontal supporter when the linear actuator of FIG. 14 further includes a guide member, a restriction member and a support member.

FIG. 19 is a view illustrating the arrangement of elements making up a horizontal supporter when the linear actuator of FIG. 14 does not further include the guide member, the restriction member and the support member.

FIG. 20 is a perspective view of a linear actuator according to another embodiment of the disclosure.

FIG. 21 is a view illustrating the linear actuator of FIG. 20 before twisting.

FIGS. 22 and 23 are views illustrating the arrangement of elements making up a cross-shaped supporter of the linear actuator of FIG. 21.

FIG. 24 is a view illustrating a wearable unit according to an embodiment of the disclosure and the mechanism of the wearable unit.

### MODE FOR INVENTION

Details of embodiments are involved in the detailed description and the accompanying drawings.

The merits and features of the disclosure and methods of achieving the merits and features will become apparent from the following embodiments described in detail in conjunction with the accompanying drawings. However, the disclosure is not limited to the following embodiments, but may be implemented in various different ways. The embodiments are provided to merely complete the disclosure and allow a person having ordinary knowledge in the art to which the disclosure pertains to fully understand the scope of the disclosure. The disclosure is defined by the scope of the appended claims. Like reference numerals refer to like elements throughout the specification.

Hereinafter, the embodiments of the disclosure will be described with reference to the following drawings to illustrate a multi-DOF wearable assistance device.

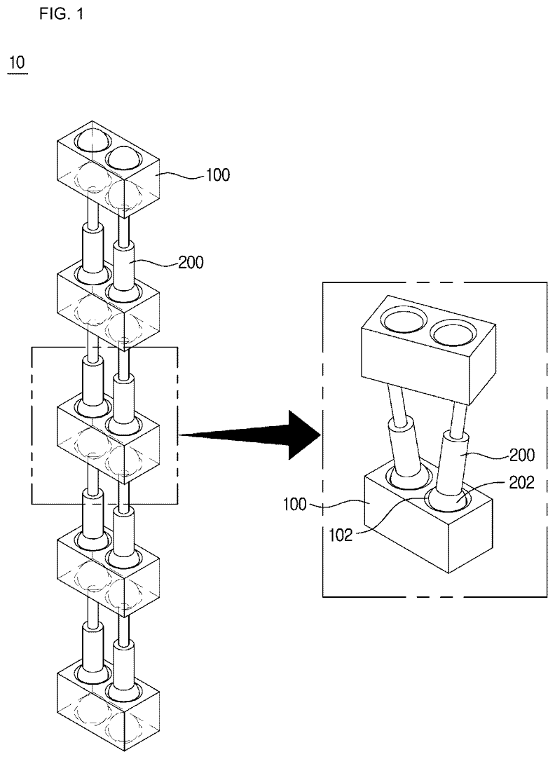

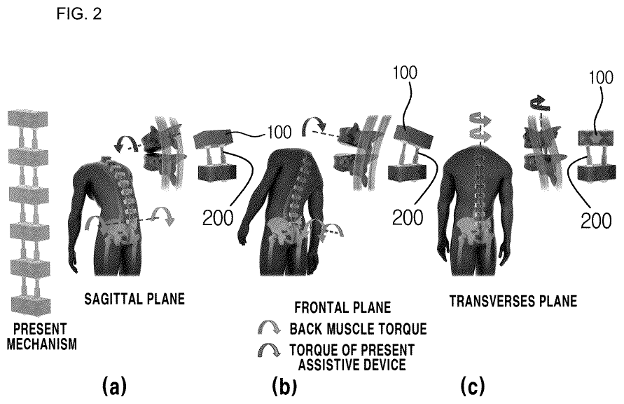

FIG. 1 is a view illustrating a basic mechanism of a multi-DOF wearable assistance device according to an embodiment of the disclosure, and FIG. 2 is a view illustrating a concept of transmitting assistive forces corresponding to multi-degrees-of-freedom movements such as forward-and-backward bending, left-and-right bending, and twisting of a human upper body while allowing the multi-degrees-of-freedom movements by the mechanism of FIG. 1.

The multi-DOF wearable assistance device according to an embodiment of the disclosure is worn on a human body to provide assistive forces for assisting various movements of a human body while allowing those movements. The multi-DOF wearable assistance device according to the disclosure is described as a device that is mounted to the back of a wearer to assist the movements of the vertebra (the human upper body), but the concept of the multi-DOF wearable assistance device according to the disclosure described below may be expanded and used as a device that is mounted to other parts of the human body, which have the multi-degrees-of-freedom movements, thereby assisting various movements.

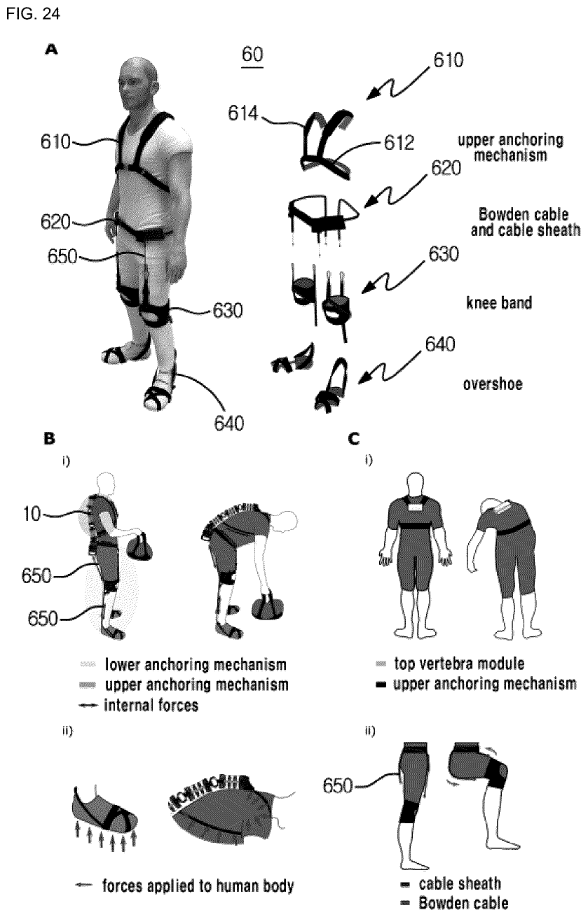

The multi-DOF wearable assistance device according to an embodiment of the disclosure may include a main body 10 transformed depending on the movement of a human body and providing an assistive force, and a wearable unit 60 making the human body wear the main body 10. The wearable unit 60 will be described later with reference to FIG. 24.

In the multi-DOF wearable assistance device according to an embodiment of the disclosure, the main body 10 may include a plurality of blocks 100, linear actuators 200, and joint connectors.

As shown in FIG. 1, the blocks 100 may be arranged to be spaced apart along the human body. In this case, the blocks 100 may be spaced apart up and down as illustrated in FIG. 1 when mounted to a wearer's back.

The linear actuators 200 may be disposed from side to side in parallel forming a pair between the blocks 100 which are arranged to be spaced apart from each other.

The joint connector provides a joint connection such that a connection angle between the block 100 and both ends of the linear actuator 200 can be freely changed. In this case, the joint connector may be formed to connect the linear actuator 200 and the block 100 by a ball-socket joint. For example, as shown therein, spherical balls 202 may be formed at both ends of the linear actuator 200, and a spherical socket 102 may be formed in the block 100 to insert the ball 202 therein. Therefore, the upper and lower ends of the linear actuator 200 are coupled by the ball-socket joints, so that a connection angle between the block 100 and the linear actuator 200 placed in an upper portion of the block 100 and a connection angle between the block 100 and the linear actuator 200 placed in a lower portion of the block 100 can be freely changed.

The foregoing configuration is based on the biomechanical features of a human's vertebrae and erector spinae muscles, in which the blocks 100 are analogous to the vertebrae of a human body and the linear actuator 200 are analogous to the erector spinae muscles.

As shown in (a) of FIG. 2, when the human upper body leans forwards or backwards, the two linear actuators 200 disposed in parallel between the blocks 100 are increased in length, and the main body 10 may be bent according to the forward-and-backward leaning movements of the human upper body based on the angle change of the joint connector. In this case, the forward-and-backward leaning movements of the human upper body may be detected, and the linear actuator 200 may be operated according to the detected movements of the human upper body, thereby providing the assistive forces to the human upper body.

Further, as shown in (b) of FIG. 2, when the human upper body leans leftwards or rightwards, the two linear actuators 200 disposed in parallel between the blocks 100 are changed in length differently from each other, and the main body 10 may be bent in left and right directions according to the leftward-and-rightward leaning movements of the human upper body based on the angle change of the joint connector. In this case, the leftward-and-rightward leaning movements of the human upper body may be detected, and the linear actuator 200 may be operated according to the detected movements of the human upper body, thereby providing the assistive forces to the human upper body. In the case where the human upper body leans rightwards as shown (b) of FIG. 2, the main body 10 may be transformed corresponding to that movement by increasing the length of the linear actuator 200 disposed on the left side among the linear actuators 200 arranged left and right in parallel.

Further, as shown in (c) of FIG. 2, even when the human upper body is twisted, the two linear actuators 200 arranged in parallel between the blocks 100 may be changed in length according to the twisting motion, and the main body 10 may be transformed to twist according to the twisting motion of the human upper body based on the angle change of the joint connector based on the twisting motion. In this case, the twisting movement of the human upper body may be detected, and the linear actuator 200 may be operated according to the detected movement of the human upper body, thereby providing an assistive force to the human upper body.

A conventional torque-based wearable human upper-body assistive device provides an assistive force by moving a chest pad disposed on a chest in frontward and backward directions with a motor disposed at a hip joint area and used as a central axis. Although the torque-based wearable human upper-body assistive device as described above has a simple structure, an assistive force is provided only when the human upper body moves in the forward and backward directions (only in one direction), and the chest pad cannot move when the human upper body leans leftwards or rightwards or twists, thereby imposing restrictions on various movements of the human upper body.

On the other hand, the multi-DOF wearable assistance device according to the disclosure may be transformed corresponding to various movements of a human body by a structure that mimics a human's spinal structure, thereby providing the multi-DOF assistive forces.

The detailed structure of the multi-DOF wearable assistance device according to an embodiment of the disclosure will be described based on the basic mechanism described with reference to FIGS. 1 and 2.

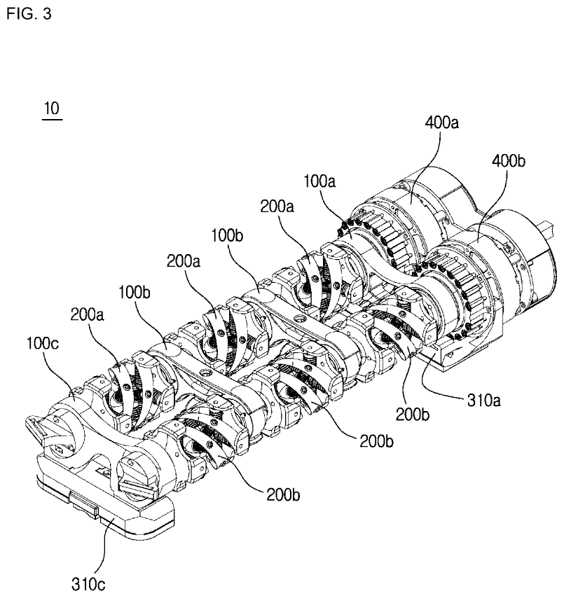

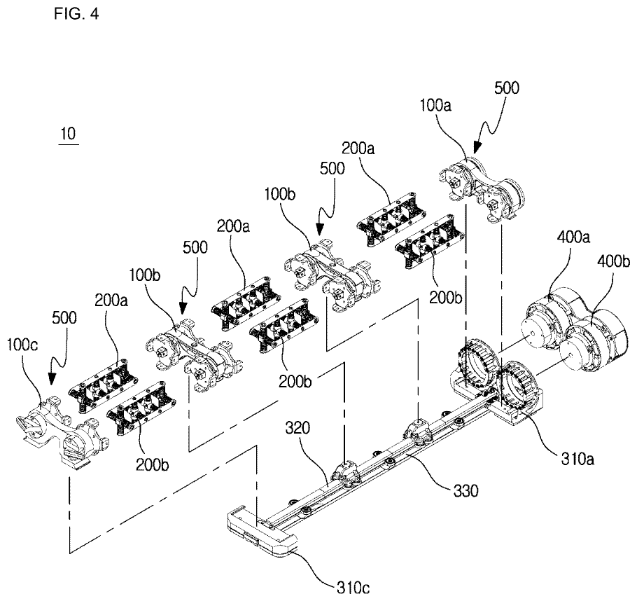

FIG. 3 is a perspective view of a main body in a multi-DOF wearable assistance device according to an embodiment of the disclosure, and FIG. 4 is an exploded perspective view of FIG. 3.

As shown in FIG. 4, a plurality of blocks 100a, 100b, 100c may be spaced apart up and down. The multi-DOF wearable assistance device is to assist the movement of the vertebra, and the main body 10 may be mounted on the back of a wearer. Therefore, when the multi-DOF wearable assistance device is worn, the plurality of blocks 100a, 100b, 100c may be spaced apart up and down along the back. In this embodiment, four blocks 100a, 100b, 100c are spaced apart up and down by way of example, but there are no limits to the number of the blocks 100.

In this case, the two outermost blocks 100a and 100c among the plurality of blocks 100a, 100b, 100c may be fixed to holding frames 310a and 310c, respectively, and one or more blocks 100b positioned in the middle may be configured to move up and down along a guide rail 320 which connects in a straight line between the holding frames 310a and 310c positioned above and below. In this regard, detailed configuration will be described later.

The linear actuators 200 may be disposed left and right in parallel between the neighboring blocks 100 respectively. In the accompanying drawings, three pairs of linear actuators 200 may be disposed in parallel between four blocks 100.

A rotary motor 400 may be disposed on an outer first side of the outermost block 100a among the plurality of blocks 100a, 100b, 100c. In the accompanying drawings, the rotary motor 400 is disposed on the outer first side of the block 100a which is located at the bottom. In this case, the rotary motors 400a and 400b may be arranged in pair on the left and right to drive the linear actuators 200 arranged in rows on the left and right, respectively. In other words, the rotary motor 400a positioned on the right may drive the linear actuators 200a positioned on the right among the three pairs of linear actuators 200 in a lump, and the rotary motor 400b positioned on the left may drive the linear actuators 200b positioned on the left among the three pairs of linear actuators 200 in a lump.

As shown in FIG. 1, the linear actuators 200 disposed between the blocks 100 may be driven individually, but in this case, the configuration for individually driving the linear actuators 200 may be complicated. Thus, according to the disclosure, the pair of rotary motors 400 generating power is provided in the outermost block 100a, so that the plurality of linear actuators 200a and 200b disposed in two rows can be driven at once based on the power generated by the pair of rotary motors 400a and 400b.

In this embodiment, the linear actuator 200 receives a rotational force from the rotary motor 400 and performs an elastic linear contraction movement by torsional rotation. The detailed configuration of the linear actuator 200 will be described later.

The joint connector 500 provides a joint connection so that a connection angle between the block 100 and both ends of the linear actuator 200 can be freely changed. Further, in this embodiment, the joint connector 500 is required to transmit the rotational force from the rotary motor 400 located on the first side of the outermost block 100a to the linear actuator 200 located on an upper side. In the configuration of FIGS. 1 and 2, a structure for transmitting power through the joint connector 500 is not necessary because the linear actuators 200 are driven individually. On the other hand, according to this embodiment, it is necessary to transmit the power of the rotary motor 400 to the linear actuators 200a and 200b arranged in a row through the joint connector 500. The detailed structure of the joint connector 500 is as follows.

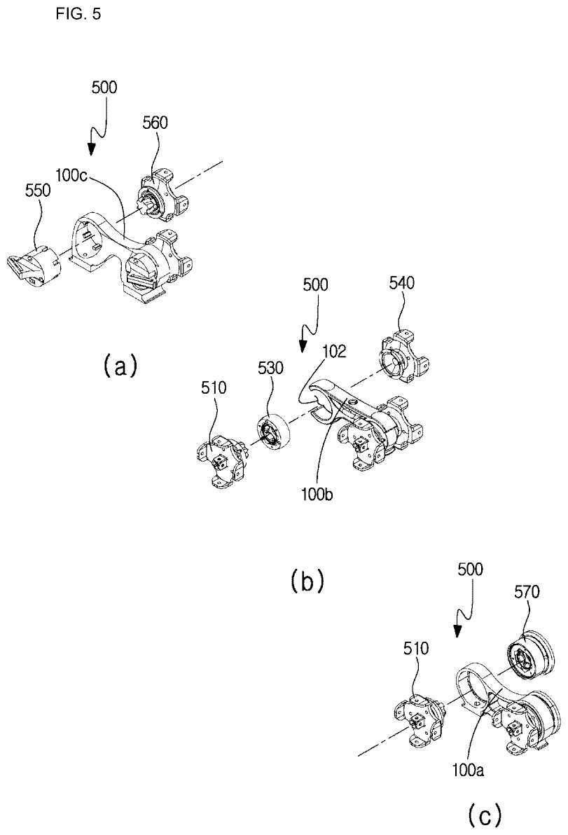

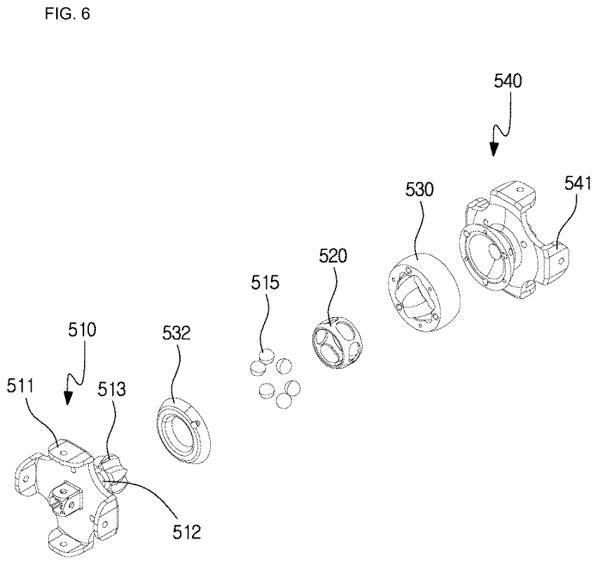

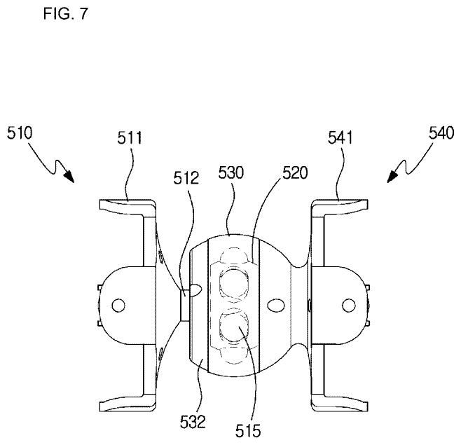

FIG. 5 is an exploded perspective view of a joint connector, FIG. 6 is a detailed exploded perspective view of the joint connection disposed between linear actuators in FIG. 5, and FIG. 7 is an assembled perspective view of FIG. 6.

As shown in FIG. 5, the joint connector 500 may be formed in a portion where the block 100 and the linear actuator 200 are connected, and the joint connectors 500 formed in the outermost blocks 100a and 100c may be slightly different in configuration from the joint connectors 500 formed in the middle blocks 100b.

First, the configuration of the joint connector 500 formed in the middle block 100b shown in (b) of FIG. 5 and FIGS. 6 and 7 will be described.

The joint connector 500 may include a constant-velocity joint connector and a ball-socket joint connector.

The constant-velocity joint connector provides a constant-velocity joint connection between the linear actuators 200 arranged in a row with the blocks 100b therebetween. As shown in FIG. 6, the constant-velocity joint connector may include a first side holder 510, balls 515, a cage 520, an outer race 530, and a second side holder 540.

The first side holder 510 may include a fastening portion 511 for fastening a second end of the linear actuator 200 disposed on a first side of the block 100b, and an inner race 513 formed on a shaft 512 extending from the center of the fastening portion 511. The fastening portion 511 is formed protruding toward the linear actuator 200 at a position corresponding to each vertex of a square, in which the second end of the rail 210 of the linear actuator 200 may be fastened to the protruding portion.

The inner race 513 may be formed with the cage 520 which arranges a plurality of balls 515 while maintaining gaps between the plurality of balls 515, and the outer race 530 which together with the inner race 513 arranges the balls 515.

On the shaft 512 of the first side holder 510, an inner race cap 532 disposed on the first side of the inner race 513 may be provided, and the outer race 530 may be fixed on a lateral side of the inner race cap 532. Further, the second side holder 540 may be disposed on the second side of the inner race 513.

The second side holder 540 may be fixed to the second side of the outer race 530 to close the second sides of the outer race 530 and the inner race 513. In the second side holder 540, a fastening portion 541 may be formed in the same shape as the fastening portion 511 of the first side holder 510 so as to fasten the first end of the linear actuator 200 disposed on the second side of the block 100.

Through the foregoing constant-velocity joint connector, the rotational force may be transmitted to the first side holder 510 when the second side holder 540 is rotated by the rotation of the linear actuator 200 disposed on the second side of the block 100b. Further, the constant-velocity joint connection allows the first side holder 510 to be freely changed in angle around the second side holder 540. The aforementioned configuration of the constant-velocity joint connector is not limited to the illustrated form, and may be modified into various forms of the constant-velocity joint publicly known in the art.

The constant-velocity joint connector allows the rotational force to be transmitted between the linear actuators 200 with the block 100b therebetween and allows the angle of the linear actuator 200 located on the first side to be freely changed relative to the block 100b. However, the constant-velocity joint connector does not allow the angle of the linear actuator 200 located on the second side to be freely changed relative to the block 100b. This may limit the movement of the block 100b and the linear actuator 200 corresponding to various movements of the human upper body. Thus, the ball-socket joint connector solves this limitation problem so that the multi-DOF wearable assistance device according to the disclosure can be transformed according to various movements of the human upper body.

The ball-socket joint provides a ball-socket joint connection between the housing 530 of the constant-velocity joint connector and the block 100b. The housing 530 may correspond to the outer race 530 of the constant-velocity joint connector. The outer surface of the outer race 530 is formed as a part of a sphere, and the block 100b is formed with the socket 102 in which the outer race 530 is inserted and of which the inner surface has a spherical surface corresponding to the outer surface of the outer race 530, so that the block 100b and the outer race 530 forming the constant-velocity joint connector can be connected by a ball-socket joint connection. Therefore, the constant-velocity joint connector and the ball-socket joint connector are configured to allow the angles of the linear actuators 200 coupled to the first side and the second side of the block 100b to be freely changed, and at the same time allow the rotational force of the linear actuator 200b located on the second side of the block 100b to be transmitted to the linear actuator 200 located on the first side of the block 100.

The joint connector with the foregoing configuration may be formed as one pair on the left and right sides of the block 100b disposed in the middle.

Only the constant-velocity joint connectors may be formed in the joint connector 500 between the linear actuator 200 and the outermost blocks 100a and 100c.

In other words, as shown in (a) of FIG. 5, the constant-velocity joint connection may be made between the linear actuator 200 and the outermost block 100c on the first side opposite to the side where the rotary motor 400 is located. An outer race portion 550, which may correspond to the outer race 530 of the foregoing constant-velocity joint connector, may be coupled to the block 100c, and a fastening portion 560, the ball 515, and the cage 520 at an end, in which the direction of the foregoing second side holder 510 is reversed and the inner race 513 is formed, may together with the outer race portion 550 form the constant-velocity joint connection.

Further, as shown in (c) of FIG. 5, the first side holder 510 and the cylinder bearing 570 may be connected by the constant-velocity joint between the rotary motor 400 located on the second side and the linear actuator 200 located on the first side with respect to the outermost block 100a on the second side where the rotary motor 400 is located. The cylinder bearing 570 may couple with the rotary motor 400. Further, the ball-socket joint may be formed between the socket 102 formed in the block 100a and the outer surface of the cylinder bearing 570. Although it is not shown, a load cell may be disposed between the linear actuator 200 and the rotary motor 400.

The outermost blocks 100a and 100c may be fixed to the holding frames 310a and 310c, respectively, and the guide rail 320 is formed between the holding frames 310a and 310c to guide the up-and-down movement of the block 100b located in the middle. If the two ends of the blocks 100a and 100c are fixed but the position of the block 100b is not fixed without guiding the movement of the middle blocks 100b, the main body 10 cannot be transformed according to various movements of the human upper body because the three pairs of linear actuators 200, which are arranged in in two rows between the outermost blocks 100a and 100c, are transformed while maintaining only the shape of a straight line.

According to the disclosure, the middle blocks 100b move freely in the up and down directions along the guide rail 320 and rotate freely about a forward-and-backward directional axis, so that the main body 10 including the blocks 100 and the linear actuators 200 can be transformed according to various movements of the human upper body.

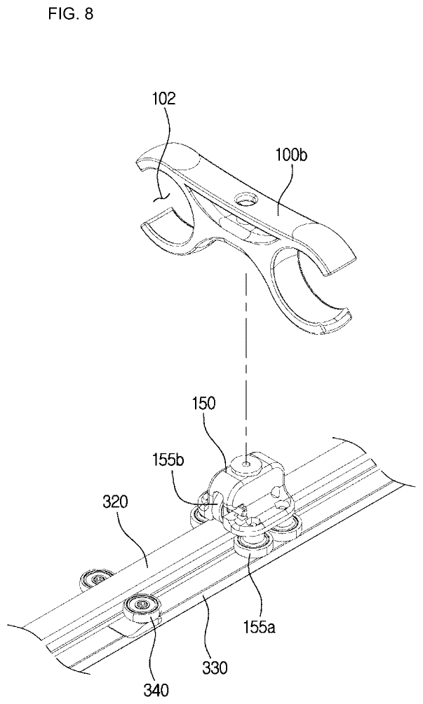

There are constraints on changing the length of the linear actuators 200 disposed between the blocks 100a, 100b, and 100c. Such a dependency problem of the length is solved by adding the aforementioned linear degrees of freedom and rotational degrees of freedom to the blocks 100b positioned in the middle, and thus the main body 10 is movable according to various movements of the human upper body without the constraints. In this regard, descriptions will be made below with reference to FIGS. 8 to 13.

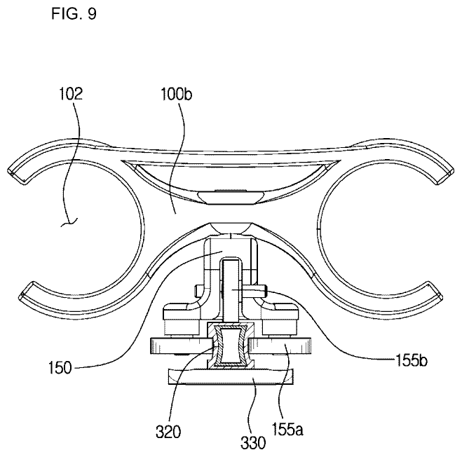

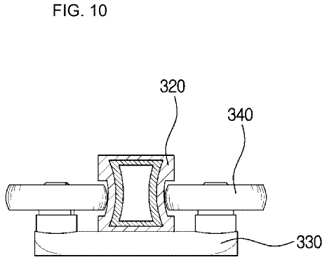

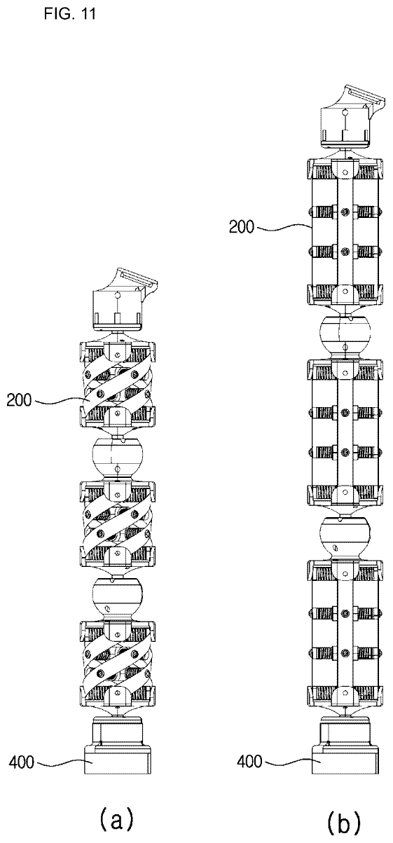

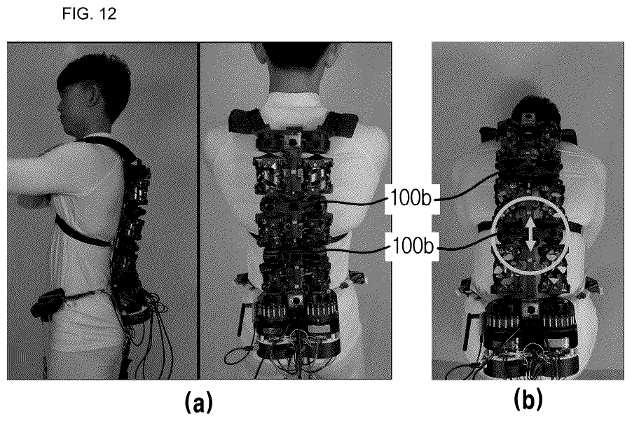

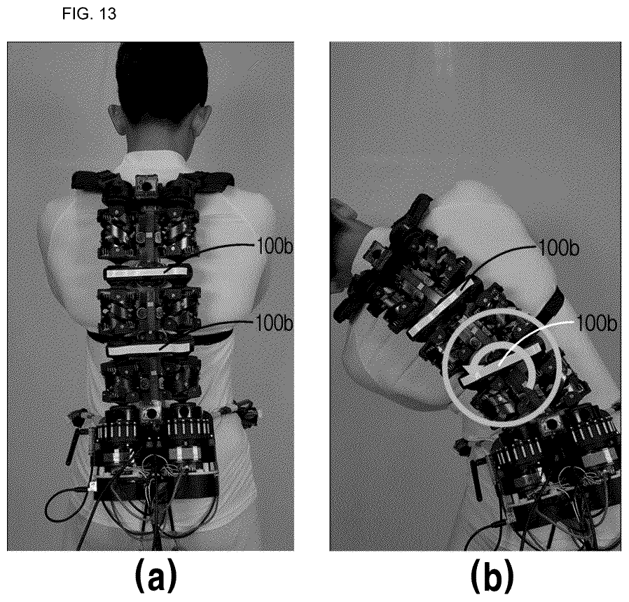

FIG. 8 is an enlarged view of a guide block and a rail supporter shown in FIG. 4, FIG. 9 is a lateral view of the guide block coupled to a guide rail in FIG. 8, FIG. 10 is a lateral view of the rail supporter coupled to the guide rail in FIG. 8, FIG. 11 is a view illustrating two movement states of a linear actuator according to an embodiment, FIG. 12 is an actual picture illustrating the movement of a multi-DOF wearable assistance device according to the disclosure based on forward-and-backward leaning movement, and FIG. 13 is an actual picture illustrating the movement of a multi-DOF wearable assistance device according to the disclosure based on leftward-and-rightward leaning movement.

The guide rail 320 connected between the holding frames 310a and 310c may be made of a flexible material to be transformed according to various movements of a human body. For example, the guide rail 320 may be made of an elastic material, i.e., thermoplastic polyurethane (TPU).

In this case, the guide rail 320 may be formed to an upper surface of the flexible support frame 330 connected between the holding frames 310a and 310c. The flexible support frame 330 refers to a frame that comes into contact with a human body, and may be made of a soft flexible material, e.g., a dragon skin to be transformed according to various movements of a human upper body when mounted to, i.e., worn on the human upper body as disclosed in the disclosure without causing discomfort to the human body.

In other words, the flexible support frame 330 and the guide rail 320 are also formed to be flexibly transformed along with the forward-and-backward bending, left-and-right bending, and twisting motions of the human upper body. Thus, the cross-section of the guide rail 320 according to the disclosure is formed like that of an I-beam, so that the blocks 100b can move up and down with a roller 155 being in contact with the guide rail 320 shaped like the I-beam, thereby maintaining the function of guiding the middle blocks 100b to move up and down even though the shape of the guide rail 320 is transformed by the movement of the human upper body.

As shown in FIG. 9, a guide block 150 may be coupled to the bottom of the block 100b. A bearing may be disposed in a coupling portion of the guide block 150, so that the guide block 150 can freely rotate with respect to the block 100b about an axis in a forward-and-backward direction (i.e., in a direction perpendicular to the plurality of blocks 100 arranged in an up-and-down direction, i.e., the up-and-down direction of FIG. 9). Further, at least one roller 155 may be disposed on the guide block 150, in which the roller 155 rotates while being in contact with the guide rail 320 while allowing the blocks 100b to freely move along the guide rail 320. The rollers 155 may include one or more pairs of horizontal rollers 155a rotating while supporting the opposite recessed sides of the guide rail 320 shaped like the I-beam, and a vertical roller 155b rotating while supporting the top of the guide rail 320.

With this configuration of the guide block 150, the block 100b can move freely up and down along the guide rail 320 with the linear degrees of freedom and the rotational degrees of freedom.

As shown in FIGS. 8 and 10, rail supporters 340 are fixed to an upper portion of the flexible support frame 330 and support both sides of the guide rail 320. In this case, a plurality of rail supporters 340 may be disposed along the longitudinal direction of the guide rail 320 in a position where the up-and-down movement of the guide block 150 is not constrained. As the guide rail 320 is interspersed with the rail supporters 340 supporting both sides of the guide rail 320, the function of guiding the guide block 150 may be better maintained even though the guide rail 320 is transformed according to the movement of the human upper body.

As shown in FIG. 10, the rail supporter 340 may include one or more pairs of horizontal rollers that are fixed to the flexible support frame 330 and horizontally rotate being in contact with the lateral sides of the guide rail 320. As described above, when the guide rail 320 has a cross-section like that of the I-beam, the horizontal rollers may be configured to rotate being in contact with both recessed sides of the guide rail 320.

FIG. 11 illustrates that the main body 10 is changed in length as the length of the linear actuator 200 (to be described later) is changed by the rotation of the rotary motor 400.

Referring to the pictures of FIG. 12, (a) shows a picture that the multi-DOF wearable assistance device according to the disclosure including the linear actuator 200 of FIG. 11 is mounted to a human upper body to have an upright posture, and (b) shows that the device when the human upper body is bent forward. When the human upper body is bent forward, the guide rail 320 including the flexible support frame 330 may be stretched up and down, and at the same time, the length of the linear actuator 200 may be stretched. In this case, the guide blocks 150 located in the middle are allowed to freely move up and down along the guide rail 320, and thus the blocks 100 are moved upward while keeping even distances therebetween.

FIG. 13 illustrates a change in the position of the block 100 when the human upper body is bent leftward, in which white tapes are attached to the middle blocks 100b to better represent the change in the position of the blocks 100. As shown in (b) of FIG. 13, when the human upper body is bent leftward, the flexible support frame 330 and the guide block 150 are transformed along the center of the human upper body according to the movement of the human upper body, and thus the increased length of the linear actuator 200 causes the middle blocks 100b to be freely changed in the distance and rotation angle therebetween. If the middle blocks 100b do not have the above-mentioned linear and rotational degrees of freedom, it is not possible to flexibly transform the device according to the human upper body movement as described above, thereby applying strain to the device.

Below, the linear actuator 200 according to the disclosure will be described.

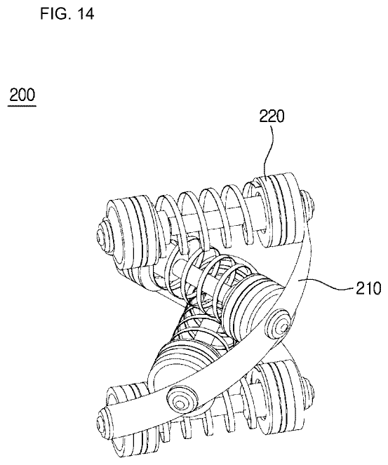

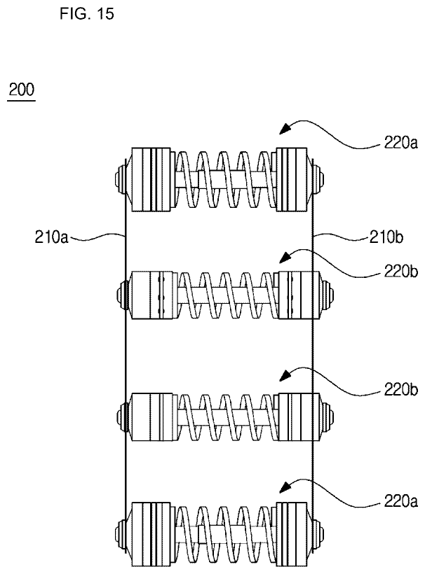

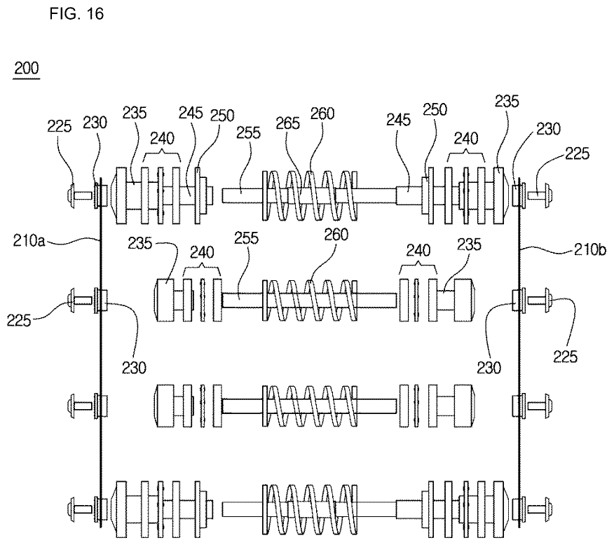

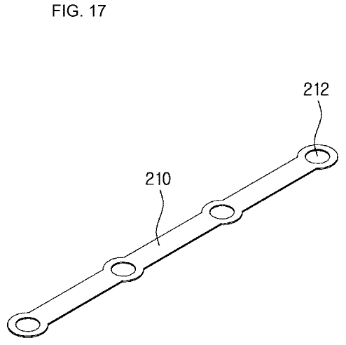

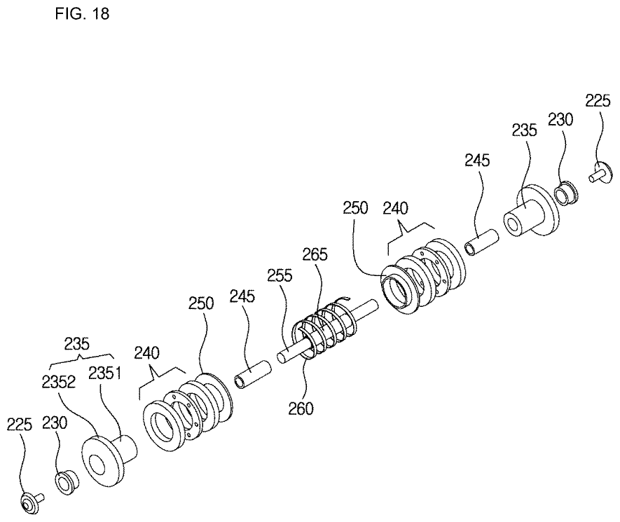

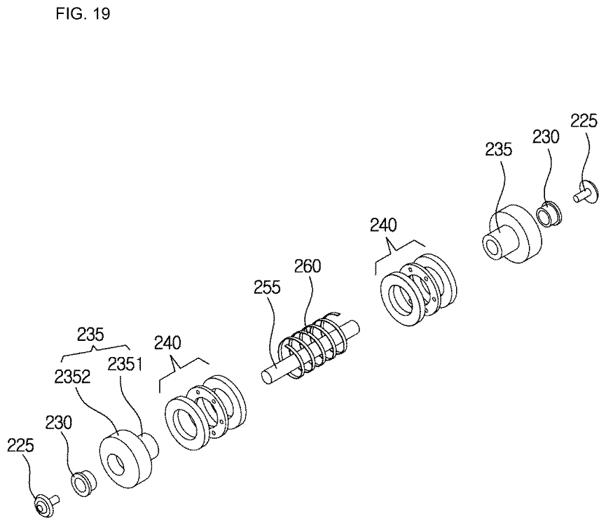

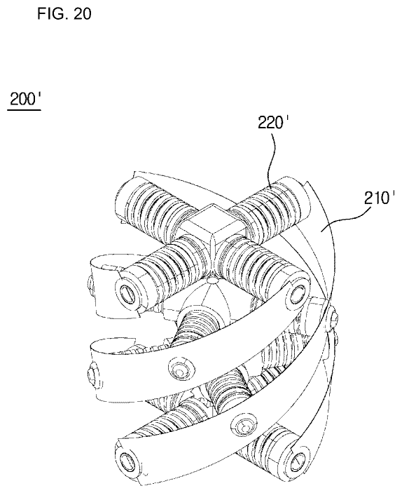

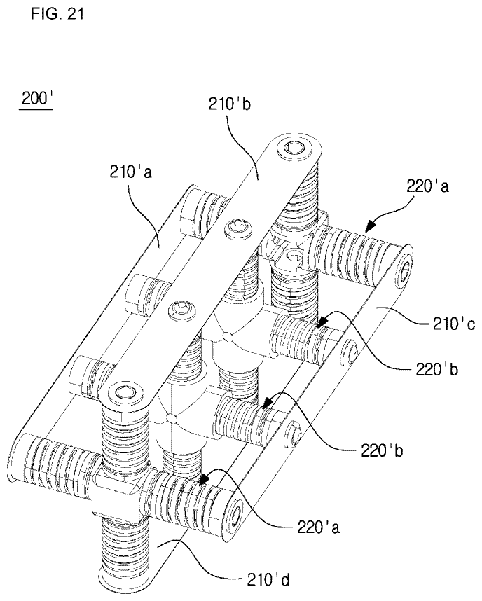

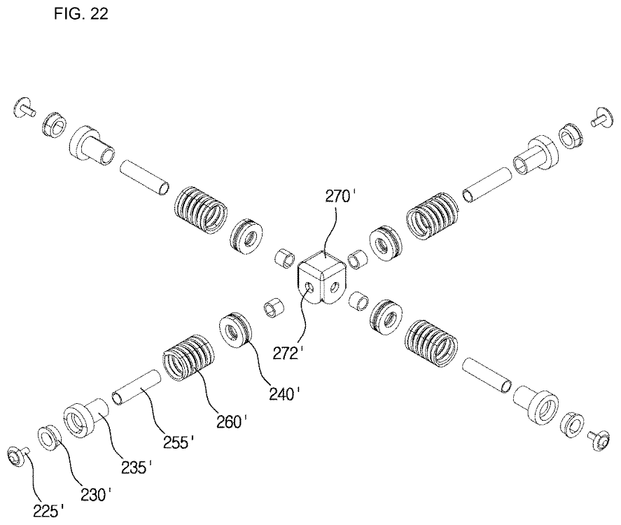

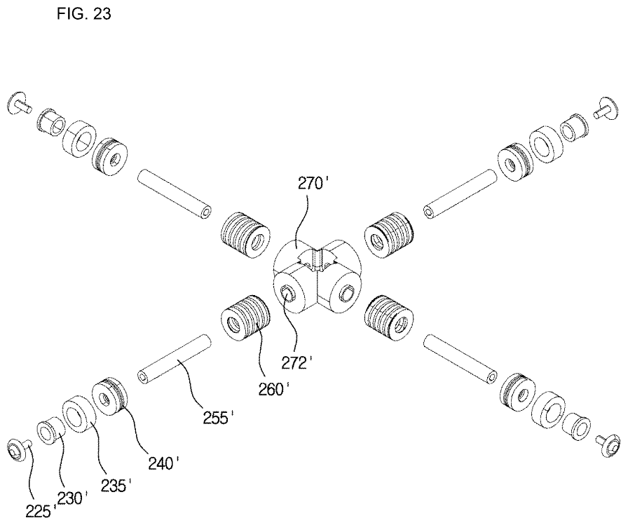

FIG. 14 is a perspective view of a linear actuator according to an embodiment of the disclosure, FIG. 15 is a view illustrating the linear actuator of FIG. 14 before twisting, FIG. 15 is a drawing illustrating a state prior to the twisting in FIG. 14, FIG. 16 is an exploded view of FIG. 15, FIG. 17 is a view illustrating a rail in FIG. 16, FIG. 18 is a view illustrating the arrangement of elements making up a horizontal supporter when the linear actuator of FIG. 14 further includes a guide member, a restriction member and a support member, FIG. 19 is a view illustrating the arrangement of elements making up a horizontal supporter when the linear actuator of FIG. 14 does not further include the guide member, the restriction member and the support member, FIG. 20 is a perspective view of a linear actuator according to another embodiment of the disclosure, FIG. 21 is a view illustrating the linear actuator of FIG. 20 before twisting, and FIGS. 22 and 23 are views illustrating the arrangement of elements making up a cross-shaped supporter of the linear actuator of FIG. 21.

For reference, FIGS. 14 to 19 illustrate the linear actuator 200 according to an embodiment of the disclosure, and FIGS. 20 to 23 illustrate a linear actuator 200′ according to an embodiment of the disclosure.

First, the linear actuator 200 according to an embodiment of the disclosure will be described with reference to FIGS. 14 to 19.

The linear actuator 200 according to an embodiment of the disclosure may include a rail 210 and a transverse supporter 220.

As shown in FIG. 15, the rail 210 may include two rails 210a and 201b spaced apart in parallel.

Further, a plurality of transverse supporters 220a and 220b may be disposed between the rails 210a and 210b and spaced apart in a longitudinal direction, and have end portions connected to the rails 210a and 210b. In this case, the distances between the plurality of transverse supporters 220a and 220b may be the same or different. The accompanying drawings illustrate, but are not limited to, an embodiment in which four transverse supporters 220a and 220b are disposed between the first rail 210a and the second rail 210b. According to an alternative embodiment of the disclosure, three or five or more transverse supporters 220 may be disposed.

The plurality of transverse supporters 220a and 220b may be identical to each other or may differ in size. Although the transverse supporter 220a disposed at each end of the first rail 210a and the second rail 210b is illustrated as being larger in size than the transverse supporter 220b disposed in the middle of the rail 210, the transverse supporters 220 are only different in size, and components making up each of the plurality of transverse supporters 220a and 220b may be identical to each other.

When the first end portion of the first rail 210a and the first end portion of the second rail 210b are rotated together by applying a torsional force in the longitudinal direction of the rail 210, the first rail 210a and the second rail 210b are transformed and the plurality of transverse supporters 220a and 220b are rotated as shown in FIG. 14, thereby shortening the length of the linear actuator 200.

The rail 210 may be shaped like a plate having a predetermined width, length, and thickness. The rail 210 is formed having the length to be long in one direction, the width smaller the length, and the thickness smaller than the width. The rail 210 may have flexibility to bend to be transformed by a torsional force, as shown in FIG. 14. However, the rail 210 may not stretch or shrink in the lengthwise direction of the rail 210.

As shown in FIG. 17, the rail 210 may be formed with a plurality of through holes 212. In the through holes 212, a shaft member 255 and a connection member 225 of the transverse supporter 220 (to be described below) are disposed to connect the transverse supporter 220 and the rail 210.

Each of the plurality of transverse supporters 220a and 220b may include the shaft member 255, the plurality of connection members 225, a plurality of linear bushings 235, a plurality of bearings 240, and an elastic member 260. Here, the plurality of linear bushings 235 may include a first linear bushing 235 and a second linear bushing 235 which are disposed to have bilateral symmetry, and the plurality of bearings 240 may include a first bearing 240 and a second bearing 240 which are disposed to have bilateral symmetry.

The first linear bushing 235, the first bearing 240, the elastic member 260, the second bearing 240, and the second linear bushing 235 may be placed in sequence on the shaft member 255.

Specifically, the shaft member 255 of the transverse supporter 220 is disposed between the first rail 210a and the second rail 210b.

The shaft member 255 may be shaped like a rod having a predetermined length in one direction and a circular cross-section. The shaft member 255 may be formed with fastening grooves (not shown) at opposite end portions thereof, and each fastening groove may have a predetermined depth in the lengthwise direction of the shaft member 255. The shaft member 255 of the transverse supporter 220 is disposed between the first rail 210a and the second rail 210b, and the first linear bushing 235, the first bearing 240, the elastic member 260, the second bearing 240, and the second linear bushing 235 are put on the shaft member 255 in sequence. The connection member 225 may be inserted into the fastening groove with the rail 210a, 210b therebetween.

The connection member 225 may be a kind of bolt. When the connection member 225 is the bolt, the inner surface of the fastening groove may be threaded. The connection member 225 (e.g., the bolt) may have a head and a threaded column. The column of the connection member 225 may be inserted into the fastening groove of the shaft member 255 after passing through the through hole 212 of the rail 210, so that the connection member 225 can be fixed to the shaft member 255.

The diameter of the through hole 212 of the first rail 210a is smaller than the diameter of the cross section of the head of the connection member 225 and is larger than the diameter of the cross section of the column of the connection member 225. Therefore, the column of the connection member 225 passes through the through hole 212 of the first rail 210a, but the head of the connection member 225 does not pass through the through hole 212 of the first rail 210a.

Further, the through hole 212 of the first rail 210a has a larger diameter than the diameter of the cross-section of the shaft member 255. Therefore, the shaft member 255 may pass through the through hole 212 of the first rail 210a. Therefore, the first rail 210a can move in the lengthwise direction of the shaft member 255 in the state that the shaft member 255 is inserted in the through hole 212 of the first rail 210a (i.e., in the state that the first rail 210a is put on the shaft member 255).

The connection member 225, the first rail 210a, and the first end portion of the shaft member 255 are connected as follows. When the column of the connection member 225 is inserted in and fixed to the fastening groove formed in the first end portion of the shaft member 255 after passing through the through hole 212 of the first rail 210a, the first rail 210a is movable along the lengthwise direction of the shaft member 255 but prevented by the head of the connection member 255 from separating from the shaft member 255 in a direction toward the head of the connection member 255 because the cross-section of the head of the connection member 225 has a larger diameter than the through hole 212 of the first rail 210a,

According to an embodiment of the disclosure, a kind of washer may be put on the column of the connection member 225.

A connection structure between the first rail 210a and the first end portion of the transverse supporter 220 is the same as a connection structure between the second rail 210b and the second end portion of the transverse supporter 220.

A coupling member 230 may be disposed in each through hole 212 formed in the first rail 210a and the second rail 210b. The coupling member 230 is shaped like a ring, inserted in the through hole 212 of the rail 210, and coupled to the linear bushing 235 while surrounding the inner circumferential surface of the through hole 212 of the rail 210. The rail 210 may be coupled to the linear bushing 235 by the coupling member 230.

The linear bushing 235 includes a first linear bushing 235 and a second linear bushing 235, which have the same structure. The linear bushing 235 includes a body portion 2351, and an extended portion 2352 protruding from a first side circumferential surface of the body portion 2351. The body portion 2351 is shaped like a cylindrical tube having a predetermined length in a certain direction and formed with a through hole formed penetrating the body portion 2351 along a central axis in the lengthwise direction. The shaft member 255 is inserted and disposed in the through hole.

With the shaft member 255 inserted and disposed in the through hole of the body portion 2351, the linear bushing 235 may move along the lengthwise direction of the shaft member 255. Specifically, when the plurality of transverse supporters 220a and 220b are rotated by a torsional force, the first linear bushing 235 and the second linear bushing 235 are movable along the lengthwise direction of the shaft member 255 by the elastic transformation of the elastic member 260 (to be described later). More specifically, when the plurality of transverse supporters 220 is rotated by the torsional force, the first linear bushing 235 and the second linear bushing 235 may move closer to or further away from each other by the elastic transformation of the elastic member 260. Therefore, when the linear bushing 235 moves along the longitudinal direction of the shaft member 255, the rail 210 coupled by the coupling member 230 may also move together along the longitudinal direction of the shaft member 255.

Further, with the shaft member 255 inserted and disposed in the through hole of the body portion 2351, the linear bushing 235 (specifically, the body portion 2351) may rotate along the central axis of the shaft member 255. Specifically, when the plurality of transverse supporters 220a and 220b are rotated by the torsional force, the first linear bushing 235 and the second linear bushing 235 may rotate about the central axis of the shaft member 255 while moving along the lengthwise direction of the shaft member 255 by the elastic transformation of the elastic member 260.

The first bearing 240 is disposed in the body portion 2351 of the first linear bushing 235, and the second bearing 240 is disposed in the body portion 2351 of the second linear bushing 235. Because the first bearing 240 and the second bearing 240 are the same bearing 240, the first bearing 240 and the second bearing 240 will be referred to as just the bearing 240 for the same description.

The shaft member 255 is disposed in the through hole formed in the body portion 2351 of the linear bushing 235, and the bearing 240 is disposed on the outer circumferential surface of the body portion 2351 of the linear bushing 235. The outer circumferential surface of the body portion 2351 comes into contact with the inner circumferential surface forming a center hole of the bearing 240. In this case, the bearing 240 may be a thrust bearing that applies load along the axis. The bearing 240 disposed on the body portion 2351 of the linear bushing 235 may move together with the linear bushing 235 along the lengthwise direction of the shaft member 255.

Because both the rails 210a and 210b are spirally twisted when the linear actuator 200 operates, the opposite linear bushings 235 rotate in directions opposite to each other. In this case, the bearing 240 allows the opposite linear bushings 235 to rotate freely in the opposite directions to each other.

When the linear actuator 200 according to the disclosure is spirally twisted for the contraction (the decrease in length), the first rail 210a and the second rail 210b can become closer to each other to compress the elastic member 260, thereby storing elastic energy. The stored elastic energy is used to restore the linear actuator 200 to the state before the contraction.

The elastic member 260 refers to an elastic body and may be a coil spring shaped like a cylinder. According to an embodiment of the disclosure, the modulus of elasticity that each elastic member 260 of the plurality of transverse supporters 220 has may be the same or different from each other. According to an embodiment of the disclosure, the modulus of elasticity that the elastic members 260 of the transverse supporters 220a disposed at the opposite ends of the rail 210 have may be lower than that of the elastic members 260 of the transverse supporters 220 disposed in the middle of the rail 210.

The plurality of transverse supporters 220 may have partially different in configuration. For example, the transverse supporters 220 formed at the opposite ends of the rail 210 shown in FIG. 16 may additionally include a plurality of guide members 245 and/or restriction members 265 and/or support members 250 as shown in FIG. 18. Here, the plurality of guide members 245 includes a first guide member 245 and a second guide member 245, and the plurality of support members 250 includes a first support member 250 and a second support member 250.

The guide member 245, the restriction member 265, and the support member 250 are placed on the shaft member 255.

Because the first guide member 245 and the second guide member 245 are the same guide member 245, the first guide member 245 and the second guide member 245 will be referred to as just the guide member 245 for the same description.

The guide member 245 is formed as a cylindrical tube having a predetermined length in a certain direction and has a through hole formed penetrating the guide member 245 along the central axis in the lengthwise direction of the guide member 245. The shaft member 255 is inserted and disposed in the through hole of the guide member 245. Further, the restriction member 265 is formed as a cylindrical tube having a predetermined length in a certain direction and has a through hole formed penetrating the restriction member 265 along the central axis in the lengthwise direction of the restriction member 265. The shaft member 255 is inserted and disposed in the through hole of the restriction member 265.

The restriction member 265 is disposed between the first guide member 245 and the second guide member 245. The restriction member 265 may restrict the movements of the guide members 245 respectively disposed on the opposite sides of the restriction member 265. Specifically, the shaft member 255 is disposed between the first rail 210a and the second rail 210b, and the first guide member 245, the restriction member 265, and the second guide member 245 are disposed being put on the shaft member 255 in sequence. In this case, the first guide member 245 and the second guide member 245 do not move along the shaft member 255 because their movements are restricted by the restriction member 265.

The linear bushing 235 is disposed on the outer circumferential surface of the guide member 245.

When the plurality of transverse supporters 220a and 220b are rotated by the torsional force, the first linear bushing 235 may move in the lengthwise direction of the first guide member 245, and the second linear bushing 235 may move in the lengthwise direction of the second guide member 245.

The shaft member 255 is disposed in the through hole of the first guide member 245, and the first linear bushing 235 is disposed on the outer circumferential surface of the first guide member 245. In other words, the first guide member 245 is disposed in the through hole formed in the body portion 2351 of the first linear bushing 235. The movement of the first guide member 245 is restricted by the restriction member 265, and the first linear bushing 235 may move in a certain direction along the lengthwise direction of the first guide member 245 or may move in the opposite direction to the certain direction. Further, the first linear bushing 235 may rotate in a certain direction along the central axis of the first guide member 245 or may rotate in the opposite direction to the certain direction.

Because the first support member 250 and the second support member 250 are the same support member 250, the first support member 250 and the second support member 250 will be referred to as just the support member 250 for the same description.

The support member 250 may be shaped like a disk having a predetermined thickness and have a through hole at the center thereof.

The body portion 2351 of the linear bushing 235 is inserted and disposed in the through hole of the support member 250. Further, the support member 250 may be disposed between the bearing 240 and the elastic member 260, thereby supporting the elastic member 260.

In this way, the first linear bushing 235, the first bearing 240, the first support member 250, the elastic member 260, the second support member 250, the second bearing 240, and the second linear bushing 235 are sequentially placed on the shaft member 255. When the first guide member 245 is disposed being put on the shaft member 255, the first linear bushing 235, the first bearing 240 and the first support member 250 are disposed on the outer circumferential surface of the first guide member 245. In this case, the first bearing 240 and the first support member 250 are disposed on the outer circumferential surface of the body portion 2351 of the first linear bushing 235. Likewise, when the second guide member 245 is disposed being put on the shaft member 255, the second linear bushing 235, the second bearing 240, and the second support member 250 are disposed on the outer circumferential surface of the second guide member 245. In this case, the second bearing 240 and the second support member 250 are disposed on the outer circumferential surface of the body portion 2351 of the second linear bushing 235.

As shown in FIG. 16, the guide members 245 may be disposed only on the shaft members 255 of the transverse supporters 220a located at both ends. When both the rails 210a and 210b are spirally twisted due to the operation of the linear actuator 200, an asymmetrical external force may be applied only to the shaft members 255 of the transverse supporters 220a located at both ends, and thus the longitudinal movement and axial rotation of the linear bushing 235 may not be smooth. To solve this problem, the guide member 245 is provided.

Below, a linear actuator 200′ according to another embodiment of the disclosure will be described with reference to FIGS. 20 to 23.

The following description will focus on difference in configuration from the linear actuator 200 which has been described with reference to FIGS. 14 to 19.

While the aforementioned embodiment shows the two rails 210a and 210b and the plurality of transverse supporters 220a and 220b, this embodiment shows four rails 210′a, 210′b, 210′c, and 210′d and a plurality of cross-shaped supporters 220′a and 220′b.

In this embodiment, the four rails 210′a, 210′b, 210′c, and 210′d may be spaced apart in parallel and quadrangularly disposed as shown in FIG. 21. Further the plurality of cross-shaped supporters 220′a and 220′b may be disposed to be spaced apart in the longitudinal direction between the four the rails 210′a, 210′b, 210′c, and 210′d, and include end portions connected to the rails 210′a, 210′b, 210′c, and 210′d.

When the end portion of the rail 210′ is rotated, the cross-shaped supporter 220′ rotates bending and transforming the rail 210′, thereby changing the length of the linear actuator 200′. In the aforementioned embodiment, the transverse supporter 220 is connected to the two rails 210a and 210b, thereby slightly lowering the stability when the rail 210 is transformed by the tortional rotation. On the other hand, in this embodiment, the cross-shaped supporter 220′ is formed to be connected and supported at four points using the four rails 210′a, 210′b, 210′c, and 210′d, so that the rail 210′ can be transformed more stably by the torsional rotation of the rail 210′.

In more detail, the configuration of the cross-shaped supporter 220′ is as follows. As shown in FIG. 22, a central connection member 270′ may be disposed at the center of the four cross-shaped supporter 220′. The central connection member 270′ may be formed with an insertion hole 272′ into which a second end portion of a shaft member 255′ is inserted. Four insertion holes 272′ may be formed in up, down, left, and right directions so that four shaft members 255′ can be inserted therein forming a cross shape.

In the through hole of the rail 210′, a coupling member 230′ described above may be inserted, and each of the shaft members 255′ may be coupled from the outside of the rail 210′ through a connection member 225′. The structure of coupling with the shaft member 255′ via the connection member 225′ is the same as that of the aforementioned embodiment, and thus detailed descriptions thereof will be omitted.

Along the shaft member 255′, a linear bushing 235′, a bearing 240′, and an elastic member 260′ may be disposed in sequence. In this embodiment, the elastic member 260′ may be disposed between the bearing 240′ and a central connection member 270′.

Alternatively, the linear bushing 235′, the elastic member 260′, and the bearing 240′ may be disposed in sequence along the shaft member 255′ as shown in FIG. 22.

For reference, the cross-shaped supporter 220′ shown in FIG. 22 may be the cross-shaped supporter 220′ located at each end of the rail 210′, and the cross-shaped supporter 220′ shown in FIG. 23 may be the cross-shaped supporter 220′ located in the middle of the rail 210′. All the plurality of cross-shaped supporters 220′ may have the same configuration having only the shape of FIG. 22 or having only the shape of FIG. 23.

Below, a wearable unit 60 will be described with reference to FIG. 24.

FIG. 24 is a view illustrating a wearable unit according to an embodiment of the disclosure and the mechanism of the wearable unit.

In the wearable unit 60, the main body 10 having the aforementioned configuration is worn on a human body. According to the disclosure, the movement of a human upper body is assisted by the driving force of the rotary motor 400. Therefore, to stably transmit the power of the rotary motor 400 to the human body, the main body 10 needs to be worn closely onto the human body and the position of the main body 10 needs to be fixed not to be easily separated by a repulsive force to the driving force of the rotary motor 400. Besides, when it is taken into account that the main body 10 of the multi-DOF wearable assistance device according to the disclosure is worn on a human body, the main body 10 needs to be worn on the human body without causing discomfort to the wearer.

The wearable unit 60 for making a human body wear the main body 10 may include an upper body wearable unit 610, a waist wearable unit 620, knee wearable units 630, and foot wearable units 640.

The wearable unit 60 is made of a textile-based material, and the connection between the wearable units 610, 620, 630, and 640 is based on a Bowden cable 650, so that an assistive force generated by the main body 10 can be effectively transmitted to a wearer with minimal loss.

The upper body wearable unit 610 may include a chest strap 612 that encircles the wearer's chest, and a shoulder strap 614 that connects the front and back of the chest strap 612 while encircling a shoulder.

The waist wearable unit 620 may include a waist strap that encircles the waist of the wearer.

In this case, upper and lower holding frames 310a and 310c of the main body 10 may be fastened to the upper body wearable unit 610 and the waist wearable unit 620, respectively.

The knee wearable units 630 are worn on both knees of the wearer. Further, the foot wearable units 640 are worn on the feet of the wearer. In this case, the Bowden cable 650 excellent in stiffness may be connected between the waist wearable unit 620 and the knee wearable units 630 and between the knee wearable units 630 and the foot wearable unit 640.

Each line of the wearable unit 60 may be positioned as close to the lines of non-extension area as possible, thereby constraining the movement of the wearer as little as possible. Further, the foot wearable unit 640 transmits the reaction force generated by the main body 10 to the ground so that the assistive force generated by the main body 10 can be transmitted to the wearer with minimal loss of the assistive force.

The disclosure is not limited to the foregoing embodiments but may be embodied in various forms within the scope of the appended claims. Even various modifications made by any person having ordinary knowledge in the art to which the disclosure pertains are considered to be within the scope of the claims without departing from the gist of the disclosure claimed in the claims.

We claim:

1. A multi-DOF wearable assistance device, which is worn on a human body and assists movement, comprising:
a plurality of blocks arranged to be spaced apart along the human body;
a linear actuator disposed left and right in parallel between the neighboring blocks; and
a joint connector providing a joint connection to freely change a connection angle between the block and opposite ends of the linear actuator.

2. The multi-DOF wearable assistance device of claim 1, wherein the joint connector provides a ball-socket joint connection between the block and the linear actuator.

3. The multi-DOF wearable assistance device of claim 1, further comprising rotatory motors disposed left and right in parallel on an outer first side of an outermost block among the plurality of blocks, and each driving the plurality of linear actuators arranged in a row between the blocks,
wherein the linear actuator receives a rotational force from the rotary motor and performs torsional rotation for linear contraction and expansion movements.

4. The multi-DOF wearable assistance device of claim 3, wherein the joint connector comprises:
a constant-velocity joint connector that provides a constant-velocity joint connection between the neighboring linear actuators arranged in a row with the blocks therebetween; and
a ball-socket joint connector that provides a ball-socket joint connection between a housing of the constant-velocity joint connector and the block.

5. The multi-DOF wearable assistance device of claim 4, wherein the constant-velocity joint connector comprises:
a first side holder comprising a fastening portion for fastening a second end of the linear actuator disposed on a first side of the block, and an inner race formed on a shaft extending from the fastening portion;
a plurality of balls disposed in the inner race;
a cage maintaining a gap between the balls;
an outer race; and
a second side holder comprising a fastening portion for fastening a first end of the linear actuator disposed on a second side of the block, and fixed to a second side of the outer race.

6. The multi-DOF wearable assistance device of claim 5, wherein the ball-socket joint connector comprises:
the outer race having an outer surface formed as a partial spherical shape; and
a socket formed in the block to insert the outer race therein and having an inner surface curved corresponding the outer surface of the outer race.

7. The multi-DOF wearable assistance device of claim 4, wherein
the constant-velocity joint connection is provided between the linear actuator and the outermost block on a first side among the plurality of blocks, and
the constant-velocity joint connection is provided between the rotary motor and the linear actuator disposed on the first side of the outermost block on a second side among the plurality of blocks.

8. The multi-DOF wearable assistance device of claim 3, further comprising:
holding frames fixing two outermost blocks among the plurality of blocks, respectively; and
a guide rail making a connection between the holding frames,
wherein middle blocks among the plurality of blocks move up and down along the guide rail.

9. The multi-DOF wearable assistance device of claim 8, wherein the blocks moving up and down along the guide rail rotate freely about a forward-and-backward directional axis.

10. The multi-DOF wearable assistance device of claim 9, further comprising:
a guide block coupled to a bottom of a block moving up and down along the guide rail and rotating freely about the forward-and-backward directional axis; and
a roller rotatably coupled to the guide block and rotating while being in contact with the guide rail.

11. The multi-DOF wearable assistance device of claim 10, wherein
the guide rail has a cross-section shaped like a cross-section of an I-beam, and
the roller comprises a rotating while supporting opposite recessed sides of the guide rail, and a vertical roller rotating while supporting a top of the guide rail.

12. The multi-DOF wearable assistance device of claim 8, wherein the guide rail is formed of a flexible material.

13. The multi-DOF wearable assistance device of claim 8, further comprising:
a flexible support frame connected between the holding frames, holding the guide rail, and formed of a flexible material to come into contact with a human body; and
rail supporters fixed to the flexible support frame and supporting both sides of the guide rail.

14. The multi-DOF wearable assistance device of claim 13, wherein the rail supporter comprises a horizontal roller fixed to the flexible support frame and horizontally rotating being in contact with a lateral side of the guide rail.

15. The multi-DOF wearable assistance device of claim 3, wherein the linear actuator comprises:
four rails spaced apart in parallel and quadrangularly disposed; and
a plurality of cross-shaped supporters disposed to be spaced apart in a longitudinal direction between the four rails, and comprising end portions connected to the rails, and
rotation of the end portion of the rail causes the rail to be bent and transformed rotating the plurality of cross-shaped supporters to change the length of the linear actuator.

16. The multi-DOF wearable assistance device of claim 15, wherein
the cross-shaped supporter comprises:
a plurality of shaft members comprising a first end portion inserted in a fastening hole formed in each rail;
a central connection member disposed at the center of the rail and formed with an insertion hole in which a second end portion of the shaft member is inserted;
a linear bushing, a bearing, and an elastic member put on the shaft member and disposed between the rail and the central connection member; and
a connection member fixing the first end portion of the shaft member from the outside of the rail, and
the linear bushing is movable in a longitudinal direction of the shaft member by elastic transformation of the elastic member upon rotation of the cross-shaped supporter due to a torsional force.

17. The multi-DOF wearable assistance device of claim 3, wherein
the linear actuator comprises:
two rails disposed being spaced apart in parallel; and
a plurality of transverse supporters disposed being spaced apart in a longitudinal direction between the rails, and comprising end portions connected to the rails, and
rotation of the end portion of the rail causes the rail to be bent and transformed rotating the plurality of transverse supporters to change the length of the linear actuator.

18. The multi-DOF wearable assistance device of claim 17, wherein
the transverse supporter comprises:
a shaft member comprising both end portions inserted in a fastening hole formed in the rail;
a first linear bushing, a first bearing, an elastic member, a second bearing, and a second linear bushing put on the shaft member and disposed in sequence; and
a connection member fixing both end portions of the shaft member from the outside of the rail, and
the linear bushing is movable in a longitudinal direction of the shaft member by elastic transformation of the elastic member upon rotation of the transverse supporter due to a torsional force.

19. The multi-DOF wearable assistance device of claim 16 or 18, wherein the bearing comprises a thrust bearing.

20. The multi-DOF wearable assistance device of claim 5, further comprising a wearable unit that comprises:
an upper body wearable unit comprising
a chest strap to encircle a chest of a wearer and a shoulder strap to encircle a shoulder while connecting the front and back of the chest strap;
a waist wearable unit comprising a waist strap to encircle a waist of the wearer;
knee wearable units to be worn on both knees of the wearer; and
foot wearable units to be worn on feet of the wearer,
wherein the holding frames are fastened to the upper body wearable unit and the waist wearable unit, respectively, and
a cable is connected between the waist wearable unit and the knee wearable unit and between the knee wearable unit and the foot wearable unit.
